(19) United States
(12) Patent Application Publication
(10) Pub. No.: US 2013/0047501 A1
(43) Pub. Date: Feb. 28, 2013

(54) Decorative Low Maintenance Landscape Border

(71) Applicant: Brian Buck, Northfield, VT (US)

(72) Inventor: Brian Buck, Northfield, VT (US)

(21) Appl. No.: 13/598,845

(22) Filed: Aug. 30, 2012

Related U.S. Application Data
(60) Provisional application No. 61/528,829, filed on Aug. 30, 2011.

(51) Int. Cl. A01G 1/08

(52) U.S. Cl. 47/33

(57) ABSTRACT

A device that provides a protective barrier along the immediate perimeter of a dwelling impeding the germination of unwanted vegetation, entry points for rodents and water infiltration. The barrier comprises distinct sections having both male and female interlocking mechanisms capable of maintaining a secure bond, thereby increasing the structural integrity of the feature as a whole. Two profiles are created to meet the desired need of a homeowner. The first produces a horizontal walkway while the second forms an L-shaped figure providing an area to showcase landscaping materials such as dirt, mulch, flowers and shrubs. Both forms are fabricated from inexpensive and lightweight materials aiding in ease of installation when compared to current masonry products available that replicate similar features.

### CROSS REFERENCE TO RELATED APPLICATION

This application claims the benefit of U.S. Provisional Application No. 61/528,829 filed on Aug. 30 2011, entitled “Decorative Low Maintenance Landscape Border.” The patent application identified above is incorporated here by reference in its entirety to provide continuity of disclosure.

### BACKGROUND OF THE INVENTION

1. Field of the Invention

The present invention relates to landscape borders. More specifically, the present invention relates to an efficient, low maintenance and decorative solution for providing an aesthetically pleasing landscape to modular or mobile homes by eliminating the growth of weeds or other forms of unsolicited vegetation. Interlocking male and female L-shaped sections, capable of displaying a variety of ornamental textures, create a formidable barrier that encompasses the immediate perimeter of a home providing a homeowner with ample space to showcase plants, mulch or flowers without the threat of water infiltration or rodent infestation.

A significant benefit regarding a protective landscape border around the perimeter of a home is a reduction in possible rodent infestation. In many situations, the prominent entry point for rodents are penetrations in sections of the home closest to the ground. This problem is even more apparent in areas heavily populated by mobile or modular homes due to the close proximity of sewage depository sights as well as increased outside dining, thereby increasing the likelihood of unprotected food sources. Once inside a dwelling, rodents are prone to various forms of detrimental behavior, such as gnawing through electrical wiring and plastic plumbing pipes, which can lead to costly construction bills or possible fire outbreaks. From a health related standpoint, excrement left by certain types of rodents contain viruses such as the Hantavirus or Salmonellosis, which can severely impair human inhabitants, and in rare cases cause death. A protective barrier around the perimeter of the home will eliminate these entry points therefore negating the health concerns associated with rodent infestations.

Another important aspect of a protective landscape border around the perimeter of the home is to impede water infiltration and pooling. Water that penetrates the soil along the foundation perimeter will either enter the home through an opening or supply an endless source for moisture creating an environment suitable for mold growth. Once the mold has established a foothold it can have a drastic effect on both the home itself and on it's inhabitants. Some examples of the effects of mold are creating dry rot on beams, erosion of metal components, and health problems for unfortunate inhabitants who posses impaired pulmonary systems. In addition to the mold issue, pooling water underneath a home has the capacity of becoming stagnant thereby causing foul odors and attracting numerous insects such as mosquitoes.

While maintaining a well-manicured landscape denotes pride in home ownership, controlling weeds that sprout along the perimeter of the house creates an undue chore for any homeowner. The area immediately adjacent to a dwelling is not readily accessible by lawn mower and must be maintained with other landscape equipment such as a string trimmer. While utilizing this device along exterior siding of a modular home or lattice around a stationary mobile home the plastic string used as the cutting mechanism frequently breaks when it comes into contact with rigid surfaces necessitating a timely and frustrating repair. In order to negate this effort and add an aesthetically pleasing feature to the landscape, homeowners install masonry walkways fabricated from cement, pavers or bricks. These additions, although attractive, are both costly and labor intensive and over time can fail, leaving the same unwanted vegetation to seep through cracks or masonry joints. The present invention alleviates homeowners of this cost with an alternative solution that is easily installed, inexpensive and light weight, while still offering the same benefits such as water, weed and rodent protection.

2. Description of the Prior Art

The present invention addresses the prominent shortcomings relating to landscape borders that commonly reside in the art and provides a novel solution regarding an aesthetically pleasing protective barrier for the immediate perimeter of a home. Many prominent landscape borders are fabricated from pavers, bricks or concrete supplying a costly, heavy solution to negate weed growth while others are designed for deployment in a specific area, such as along fence lines. These borders are sold in small blocks that are cemented or otherwise firmly secured to the ground, which require a homeowner to expend additional funding, time and energy. Once installed, the chosen landscape materials can form various scenic focal points such as a patio or paver walkway, which add to the overall curb appeal of the property. However, even minute errors implemented during the installation process can have detrimental effects on the feature's functional life leading to failure and the inevitable requirement for additional monetary expenditures from a homeowner. In comparison to the prior art the present invention does not require any substantial amount of preparatory work or precise installation methods thereby providing more functionality in a solution that contains less weight, is less expensive and installed with a significantly less amount of labor intensive effort.

U.S. Pat. No. 6,099,942 to Yakushinji is one such device in the art that describes an apron block laid adjacently to a sidewalk for the purpose of weed control. The block itself is sloped in such a manner to aid in the runoff of water and contains an iron bar or heating wire in a recessed pocket to facilitate efficient heat transfer from the sun's energy to the asphalt directly bordering the block. This heat transfer will raise the temperature of the cavity containing the iron bar or heating wire, which is adjacent to the sidewalk and is the leading weakness for potential weed growth. With an increased temperature any vegetation germinating in the gap between the sidewalk and the block will perish thereby maintaining a weed free sidewalk. Although this invention provides a novel solution for preventing weed growth it does not prevent water infiltration or rodent infestation relating to a home, modular or mobile, and since mobile homes are typically deployed in areas without sidewalks this invention is rendered unusable in a majority of circumstances.

U.S. Pat. No. 4,497,472 to Johnson is another device that describes a means for blocking the growth of unwanted vegetation. The intended device comprises a plurality of edging strips, fence post edging structures and posts. The edging strips are fabricated with U-shaped slots capable of securely mounting to the fence posts from which the fence material extends. Once installed the material of the edging strips extends at a downward angle until coming in contact with the ground. The surface area covered by the edging strips act as a vegetation barrier physically obstructing any germination contained within the edging strip footprint. The Johnson device presents a simple solution to inhibit vegetation growth along fence posts yet does not address rodent or water issues due to its narrow application parameters. Without addressing the barrier issues existing around the immediate perimeter of the home this invention does not disclose a solution as dynamic as the present invention.

U.S. Pat. No. 5,660,374 to Dayberry is another device that describes a means for blocking unwanted vegetation comprising an elongated convex section of material with a U-shaped central portion for concealing the bottom portion of a fence line or acting as a tie down plane regarding the insertion of spikes. Dayberry's invention is more versatile than others found in the art due to the fact that it can be deployed along the bottom of a fence line or as a separate entity in any location. While the central U-shaped section will conceal either a bottom section of fence or spikes utilized to hold the invention in place there still exists no aesthetic value to this device nor will it deter the advances of free flowing water and rodents. The circular cross section appears to achieve the highest level of functionality along a fence line where it creates a barrier for the advancement of weeds directly beneath it and securely holds the fencing material in place. Outside of this specific use, Dayberry's disclosure does not provide the diverse level of functionality, as does the present invention.

U.S. Pat. No. 4,903,947 to Groves and U.S. Pat. No. 4,548,388 to Cobler are additional devices that describe a means to eliminate the germination of unsolicited vegetation underneath a fence line utilizing a base extrusion that provides a physical barrier. The Cobler invention deviates from the normal by incorporating a strip of insulation interposed between the fence line footprint, thereby implementing an additional barrier preventing the growth of vegetation. These devices present a novel solution for eliminating unsolicited vegetation within the confines of a fence line yet fail to provide the additional benefits of the present invention relating to an aesthetically pleasing barrier that encircles the immediate perimeter of a home preventing water intrusion and rodent infestation.

From the brief description of prominent devices in the art it is plainly gathered that the present invention provides a novel landscape barrier device, and therefore substantially diverges in design elements from the prior art. Consequently it is clear that there is a need in the art for an improvement to existing landscape barriers. In this regard the instant invention substantially fulfills these needs.

### SUMMARY OF THE INVENTION

In view of the foregoing disadvantages inherent in the known types of protective landscape barriers now present in the prior art, the present invention provides a new protective landscape barrier wherein the same can be utilized for providing convenience for a user in the form of an aesthetically pleasing landscape barrier that offers protection against water infiltration as well as rodent infestation.

It is therefore an object of the present invention to provide a new and improved protective landscape barrier device that has all of the advantages of the prior art and none of the disadvantages.

It is another object of the present invention to provide a protective landscape barrier eliminating the germination of unsolicited vegetation directly adjacent to a home.

Another object of the present invention is to provide a landscape barrier that is inexpensive and lightweight.

Another object of the present invention is to provide a landscape barrier that provides a moisture barrier guarding against water infiltration around the immediate perimeter of the home.

Another object of the present invention is to provide a landscape barrier that provides protection against entry of rodents into a dwelling.

Another object of the present invention is to provide a landscape barrier comprising rounded vertical corners negating any possible safety issues involving sharp masonry edges.

Another object of the present invention is to provide a landscape barrier that forms an enclosed volume for the purpose of showcasing various landscaping materials.

Another object of the present invention is to provide a landscape barrier that is capable of providing a plurality of different texture options to better solve a homeowner's individual need.

Yet another object of the present invention is to provide a landscape barrier comprising of male and female interlocking sections for ease of installation.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows the present invention in a working manner, deployed along the immediate perimeter of a home.

FIG. 2 shows another embodiment of the present invention in a working manner forming a walkway lining the immediate perimeter of a home.

FIG. 3 shows a close up view of the present invention in a working manner.

FIG. 4 shows an isometric view of both forms of the present invention in a non-working manner.

FIG. 5 shows a close up view of the installation procedures of the present invention.

### DETAILED DESCRIPTION OF THE INVENTION

Reference is made herein to the attached drawings. Like reference numerals are used throughout the drawings to depict like or similar elements of the protective landscape barrier. For the purposes of presenting a brief and clear description of the present invention, the preferred embodiment will be discussed as used for providing a decorative landscape barrier. The figures are intended for representative purposes only and should not be considered to be limiting in any respect.

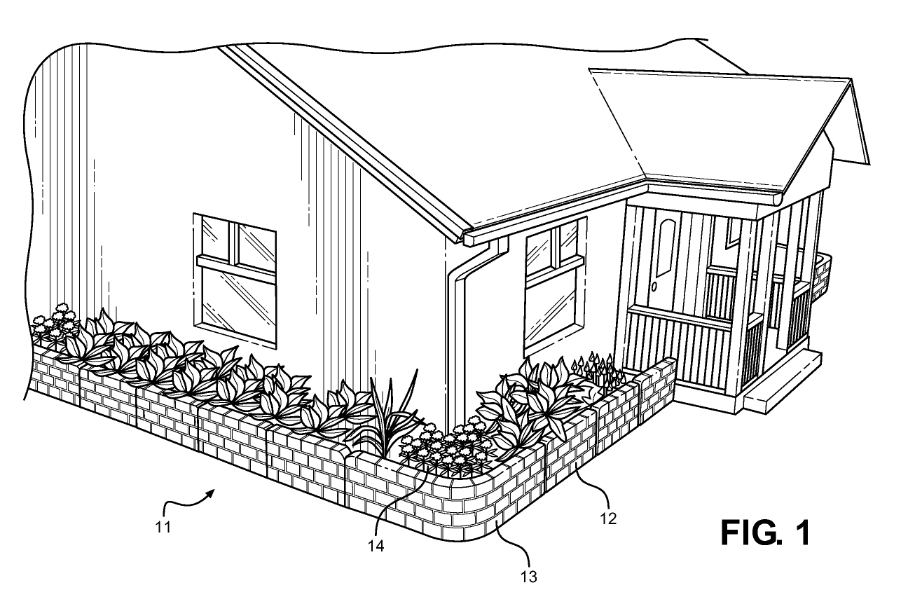

Referring now to FIG. 1, there is shown an isometric view of the present invention 11 deployed along the immediate perimeter of a home. When installed, the present invention 11 forms a controlled volume 14 that has the capacity to hold assorted landscaping materials such as mulch, shrubs, decorative plants, flowers and other wildlife deemed appropriate by a homeowner thereby creating an aesthetically pleasing landscape. Different types of sections are needed in order to create the displayed seamless outline. As shown, uniquely fabricated curved sections 13 create a rounded edge providing the capacity to arc around corners while straight sections 12 are utilized to run parallel to exterior walls. The differently shaped sections all utilize the same male and female interlocking mechanism to adhere thereby not requiring new installation methods associated with forming different shapes.

Traditionally, landscape features are fabricated from rigid and dense materials such as brick, pavers, or stone that require masonry adhesives for installation. Working with these materials is a costly endeavor that entails an immense amount of time and labor forcing many homeowners to forgo much needed landscape improvements. The present invention provides imitation landscape features that possess the same benefits as formed structures using masonry products, yet does not require installation experience or expertise in the field. An imitation landscape constructed with the present invention wall can be completed in a single evening transforming the exterior of a home into a pleasing landscape.

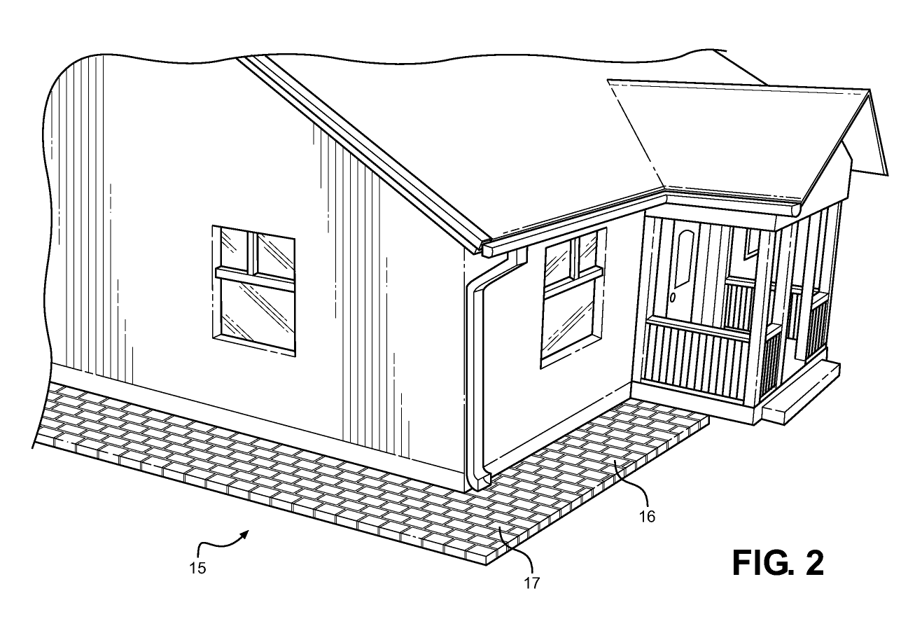

Referring now to FIG. 2, there is shown another embodiment of the present invention forming a horizontal walkway. This embodiment of the present invention 15 is a simplified version that does not provide a controlled volume to showcase landscaping materials, yet adds a distinguished feature to the landscape with the additional benefits of rodent and water protection. The horizontal sections 16 of the walkway are installed around the immediate perimeter of a home and may contain male and female interlocking mechanisms on opposite sidewalls adjacent to the plane in contact with the exterior of a home while the corner sections 17 may contain male and female locking mechanisms on planes separated by ninety degrees which provides two smooth outer edges with the locking mechanisms concealed by adjoining sections of walkway. These sections need not contain male and female interlocking mechanisms to achieve the intended functionality of a protective barrier. Circular holes for spikes or landscape ties along with the male and female interlocking mechanism are options to further the structural integrity of the feature as a whole.

A substantial need for modular and mobile homes in the housing market is predicated on the necessity for temporary living quarters, such as in the wake of a natural disaster in which an abundant amount of people are displaced or minimal needs such as an onsite construction office. These housing options offer inexpensive and temporary solutions thereby lessening the will of a homeowner to spend a lot of time and money developing the land for future resale. The present invention offers a novel solution for a homeowner to add a noticeable improvement without an extreme burden.

The present invention can be fabricated from various amounts of materials and display a plurality of different textures to suit the individual needs of a homeowner. The material must be durable in order to sustain a significant functional life while remaining within the elements firmly secured to the ground. Plastics, laminates, composites and fiberglass are suitable materials to accomplish the harsh demands expected from landscape barriers while still offering a lightweight solution.

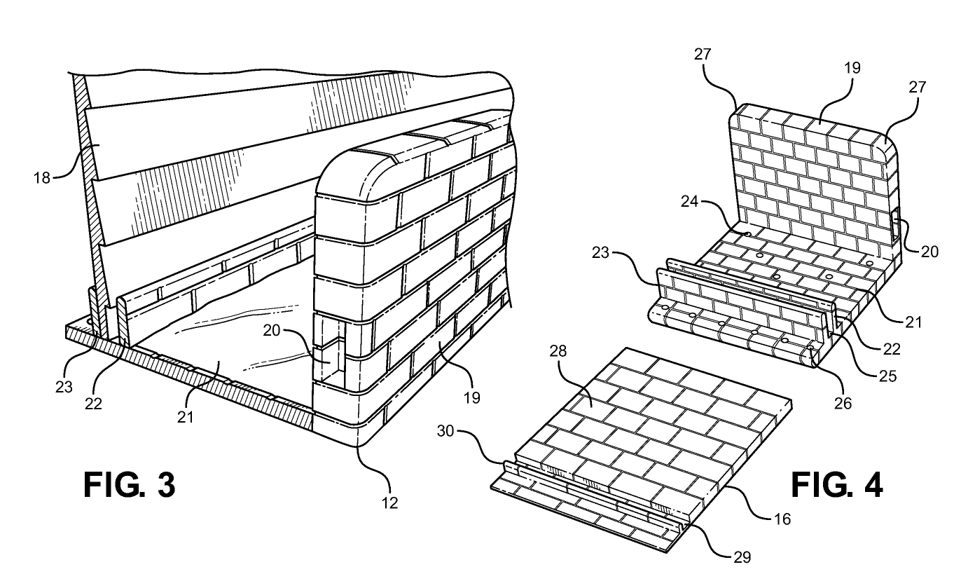

Referring now to FIG. 3, there is shown a close up isometric view of the L-shaped form 12 of the present invention 11 in a working manner. The L-shaped form 12 of the present invention becomes apparent with a vertical wall 19 representing the surface area most visible to pedestrians. A recessed cavity 20, dimensioned to receive an extruded male counterpart is visualized, creating a need for caps that are dimensioned to fit inside of the female cavities for instances where further installation of barrier sections is not feasible and a smooth outer wall is desired for aesthetic purposes. In the case where a male extruded volume is cantilevered from the final section installed, the extruded volume is fabricated to be removable thereby providing a homeowner with versatility relating to installation. Directly connected to the elevated vertical wall 19 is a horizontal portion 21 of material that acts as a base providing a substantial amount of surface area in contact with the ground. The horizontal portion 21 terminates at a small vertical extrusion 23 extended parallel to the frontal vertical wall 19 and minimally spaced from a second and equally dimensioned vertical extrusion 23 that extends at an equal incline. The two vertical extrusions produce a U-channel recess, dimensioned to capture popular sizes of exterior siding 18 or lattice material commonly found on the exterior of modular or mobile homes. This feature adds security to the exterior siding as well as the barrier itself providing an additional anchor point and further integrating the present invention into the landscape.

The present invention supplies a means to block the growth of weeds, water infiltration and rodent entry points while still maintaining an aesthetically pleasing landscape. The area immediately adjacent to a dwelling is not readily accessible by lawn mower and must be maintained with other landscape equipment, such as a string trimmer. While utilizing this device along exterior siding of a modular home or lattice around a stationary mobile home the plastic string used as the cutting mechanism frequently breaks when it comes into contact with rigid surfaces necessitating a timely and frustrating repair. The present invention negates this issue with a permanent and fixed solution that physically blocks the germination of unsolicited vegetation. In addition to this benefit the present invention also creates a barrier for water directed towards the base of a home. This physical barrier will divert the water flow as well as rodents that attempt entry into the interior of the home.

Referring now to FIG. 4, there is shown an isometric view of the L-shaped section 12 of the present invention in a non-working manner. The L-shaped section 12 is visualized with an elevated frontal wall 19 orthogonally connected to a horizontal section 21 that terminates at a vertical extrusion 22, which extends parallel to the frontal vertical wall 19. The vertical extrusion 22 contains an identical texture in comparison to the larger frontal vertical wall 19 yet is smaller in width and height. A space 25 exists on the opposite side of the vertical extrusion 22 separating the smaller vertical extrusion from an identical vertical extrusion 23, having both equal dimensions and angle of extension. These two vertical extrusions produce a U-channel recess 25, dimensioned to provide a means to capture and secure popular sizes of siding or lattice material commonly found on the exterior of modular and mobile homes. Apertures 24 are present through the horizontal portion of the L-shaped section in order to add water leeching functionality as well as tie down points to be used in conjunction with spikes or landscape ties, which are commonly used to hold such fixtures. The rear of the L-shaped section 12 also contains similar apertures 26 as additional anchoring points to further secure the present invention. Curved edges 27 along the vertical peripherals of the frontal wall 19 negate possible safety issues concerning traditionally sharp corners of masonry walls.

Referring to FIG. 4, there is shown an isometric view of the horizontal form 16 of the present invention in a non-working manner. The horizontal section 16 is used to create a walkway along the immediate perimeter of a home thereby creating a landscape focal point without extreme cost or labor expenditures. A substantial portion of this form is horizontal relative to the installed surface thereby providing a barrier to eliminate the germination of unsolicited vegetation, water infiltration and rodent infestation. The main horizontal section 28 terminates at the beginning of a recess cutout 29 that extends the entire length of the section. After a short distance, dimensioned to capture popular sizes of exterior siding as well as lattice materials commonly found on modular and mobile homes, a vertical extrusion 30 emerges orthogonally, creating a U channel recess. Apertures can be added through this horizontal form in conjunction with spikes or landscape ties in order to increase the structural integrity of the final product when installed, whereby the ties secure through the provided apertures and into a ground surface. Male and female interlocking mechanisms displayed with the L-shaped forms are an available option to further aid in strengthening the overall structure.

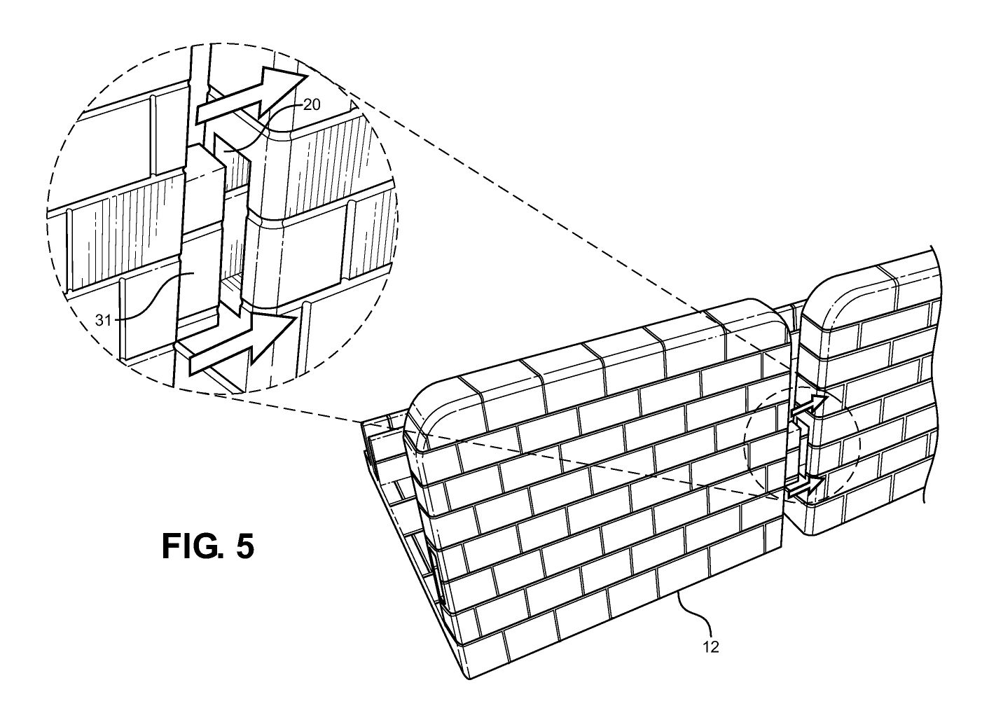

Referring now to FIG. 5, there is shown a close up view of a male and female interlocking mechanism undergoing the joining process. For a proper installation to occur a male extruded volume or protruding tab 31 translates toward a female recessed cavity 20 that encapsulates the tab 31 without causing any undo friction within. The mating of the male tab 31 and female recessed cavity 20 is constructed to insure a positive capture while both sections are located on a level surface intentionally leaving minimal space for the homeowner to optionally add the use of adhesive to strengthen the bond between adjoining sections. Once joined, the landscape barrier provides a decorative and continuous wall with the additional benefits of blocking the germination of unwanted vegetation, water infiltration and rodent entry points.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A decorative landscape barrier deployed along the immediate perimeter of a home, comprising:
an L-shaped section having an upstanding frontal wall orthogonally connected to a horizontal portion;
said horizontal portion having a U-channel therealong for the purpose of capturing exterior siding or other sheathing material.

2) The device of claim 1, wherein said L-shaped section further comprises:
a first and second lateral side, said first side having a protruding tab and said second side having a recessed cavity;
said recessed cavity being adapted to receive a tab of an adjacent section.

3) The device of claim 2, wherein said protruding tab is removable.

4) The device of claim 1, wherein said U-channel further comprises a first and second elevated lip extending along said horizontal portion.

5) The device of claim 1, wherein said U-channel further comprises a recess extending along said horizontal portion.

6) The device of claim 1, wherein apertures are provided through said horizontal portion for the purpose of additional anchoring or water regression.

7) The device of claim 1, wherein:
said horizontal portion further comprises a first and second lateral side, said first side having an upstanding side wall connecting to said upstanding frontal wall to form a corner;
said corner adapted to provide a continuous barrier around an edge or corner of the immediate perimeter of a home.

8) The device of claim 1, wherein frontal wall outward edges are rounded.

9) A decorative landscape barrier deployed along the immediate perimeter of a home, comprising:
a horizontal barrier section;
said horizontal barrier having a U-channel recess extending across said section for capturing exterior siding or other sheathing material.

10) The device of claim 9, wherein said U-channel recess is bounded by said horizontal portion and a rear elevated lip extended across said horizontal barrier.

12) The device of claim 9, wherein apertures are provided through said horizontal portion for the purpose of adding additional anchoring or water regression.

13) The device of claim 9, wherein said L-shaped section further comprises:
a first and second lateral side, said first side having a protruding tab and said second side having a recessed cavity;
said recessed cavity being adapted to receive a tab of an adjacent section.

14) The device of claim 9, wherein said protruding tab is removable.

15) The device of claim 9, wherein:
said horizontal portion further comprises a first and second lateral side, said first side having an upstanding side wall connecting to said upstanding frontal wall to form a corner;
said corner adapted to provide a continuous barrier around an edge or corner of the immediate perimeter of a home.
